(19) United States
(12) Patent Application Publication
(10) Pub. No.: US 2019/0131660 A1
(43) Pub. Date: May 2, 2019

(54) SOLID-STATE BATTERY DESIGN USING A MIXED IONIC ELECTRONIC CONDUCTOR

(71) Applicant: FORD GLOBAL TECHNOLOGIES, LLC, Dearborn, MI (US)

(72) Inventors: VENKATARAMANI ANANDAN, FARMINGTON HILLS, MI (US); ANDREW ROBERT DREWS, ANN ARBOR, MI (US)

(21) Appl. No.: 15/797,045

(22) Filed: Oct. 30, 2017

(51) Int. Cl. H01M 10/0585; H01M 10/0525; H01M 4/13

(52) U.S. Cl. CPC H01M 10/0585; H01M 2004/021; H01M 4/13; H01M 10/0525

(57) ABSTRACT

An electrochemical includes a positive electrode and a negative electrode including an electronically and ionically conductive solid material. The solid conductive material defines pores configured to receive metal ions during charge to establish a reservoir. The reservoir prevents localized occurrence of surface ion depletion during discharge, precluding void formation between the negative electrode and a separator.

### TECHNICAL FIELD

The present disclosure relates to bulk solid-state batteries, and more particularly, the anode of solid state batteries.

### BACKGROUND

Solid state batteries (SSBs) provide an alternative to conventional lithium-ion batteries. Typically, SSBs include solid electrodes and a solid electrolyte material. The solid electrolytes are resistant to lithium dendrites, which can lead to internal short circuits and are an alternative to flammable and unstable liquid battery electrolytes which can create a fire hazard. Solid electrolytes for SSBs are typically used as separators between the two electrodes and must be highly conductive to lithium ions, but have very low electronic conductivity. As a result, SSBs may have very low self-discharge rates. Because of the materials used, SSBs reduce the risk of electrolyte leakage and dangerous reactions between the electrolyte and active materials, as well as providing a long shelf life and high energy density.

### SUMMARY

According to an embodiment, an electrochemical cell is disclosed. The electrochemical includes a positive electrode and a negative electrode including a solid electronically and ionically conductive material. The solid conductive material defines pores configured to receive metal ions during charge to establish a reservoir. The reservoir prevents localized occurrence of surface ion depletion during discharge, precluding void formation between the negative electrode and a separator.

According to one or more embodiments, the solid conductive material may form conductive paths defined by at least some of the pores. The paths may have a tortuosity of about 0. In certain embodiments, the solid conductive material may have a micro-pillar structure defined by the conductive paths between a current collector and the separator. In other embodiments, the solid conductive material may form conductive paths defined by at least some of the pores. The paths may have a tortuosity of greater than 0. In certain embodiments, the paths may form a random structure of solid conductive material between a current collector and the separator. In one or more embodiments, the solid conductive material may also be a current collector. In other embodiments, the electrochemical cell may further comprise a current collector attached to the solid conductive material. In one or more embodiments, the separator may be a solid electrolyte separator. In some embodiments the separator may be non-porous.

According to an embodiment, an electrode for a solid-state battery is disclosed. The electrode includes an electronically and ionically conductive solid material defining pores. The solid conductive material is configured to receive metal ions during charge to establish a reservoir that prevents localized occurrence of surface ion depletion during discharge to preclude void formation between the electrode and a separator.

According to one or more embodiments, the solid conductive material may form conductive paths defined by at least some of the pores. The paths may have a tortuosity of about 0. In certain embodiments, the solid conductive material may have a micro-pillar structure defined by the conductive paths between a current collector and the separator. In other embodiments, the solid conductive material may form conductive paths defined by at least some of the pores. The paths may have a tortuosity of greater than 0. In certain embodiments, the paths may form a random structure of solid conductive material between a current collector and the separator. In one or more embodiments, the solid conductive material may also be a current collector.

According to an embodiment, an electrochemical cell is disclosed. The electrochemical cell includes a positive electrode, a negative electrode, and a solid-electrolyte separator between the positive and negative electrodes. The negative electrode includes a solid electronically and ionically conductive material defining pores configured to receive lithium ions during charge, and release lithium ions during discharge to prevent localized occurrence of surface ion depletion. The solid-electrolyte separator defines a lithium ion interface.

According to one or more embodiments, the solid conductive material may form conductive paths defined by at least some of the pores. The paths may have a tortuosity of about 0. In certain embodiments, the solid conductive material may have a micro-pillar structure defined by the conductive paths between a current collector and the separator. In other embodiments, the solid conductive material may form conductive paths defined by at least some of the pores. The paths may have a tortuosity of greater than 0. In certain embodiments, the paths may form a random structure of solid conductive material between a current collector and the separator.

### BRIEF DESCRIPTION OF THE DRAWINGS

FIG. 1A is a schematic illustration of a conventional solid-state battery (SSB) through cycling stages (a)-(e).

FIG. 1B is a graph illustrating change in conventional cell volume over cycling stages.

FIG. 2 is a schematic illustration of a solid-state battery (SSB), according to an embodiment, at a charged (a) and discharged (b) condition.

FIG. 3 is a schematic illustration of a solid-state battery (SSB), according to an embodiment, at a charged (a) and discharged (b) condition.

FIG. 4 is a schematic illustration showing the infiltrating of the solid-state battery of FIG. 2.

FIGS. 5A-B are graphs illustrating energy density (by volume) against percent (by volume) of mixed ionic electronic conductive material.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Solid state batteries (SSB) have the potential to provide high energy density and enhanced safety tolerance compared to existing lithium ion technologies. By relying on a solid electrolyte and eliminating the use of flammable liquid electrolytes, many of the risks associated with overcharge, over-temperature, or short circuit faults can be eliminated. Existing SSBs that have demonstrated performance and durability are fabricated with very thin electrode layers (<10 microns), and thus provide low capacities suitable for use only in low energy applications, such as smart-cards, medical implants, or other microscale uses.

For higher energy requirements, such as automotive traction energy storage, SSBs generally have thicker electrodes (e.g., 30-150 microns), compared to the 1-10 micron thick electrodes common in thin film batteries. Thick electrodes for lithium ion cell manufacturing are typically fabricated by casting slurries of powders to form a thick coating on a metallic current collector foil. Slurries containing both the active material, a binder and a conductive additive (carbon) are deposited onto metal current collector foils and dried to form the electrode. When assembled into a cell, the electrodes and separator are impregnated with a liquid electrolyte which provides ionic conductivity to particles of active material within the thick electrodes. In a SSB cell with thick electrodes, a solid electrolyte is incorporated into the electrode that provides ionic conduction to utilize the active material particles that are not in direct contact with the separator.

In addition to providing ionic conductivity through the thickness of an electrode in a SSB, electronic conductivity is needed through the thickness of each electrode to its respective current collector. In a typical Li-ion cell with a liquid electrolyte, electronic conduction across the thickness of the electrode proceeds through active material particles, across bridges between active material particles formed by the conductive additive, or across the surface of active material particles, aided by the conductive additive. This network of conductive carbon in a typical electrode is provided by addition of a relatively small percentage (3-5 wt. %) of the total solids content of the electrode. Engineering the characteristics of the two separate conduction channels within the electrodes is particularly difficult for an all-solid-state battery cell.

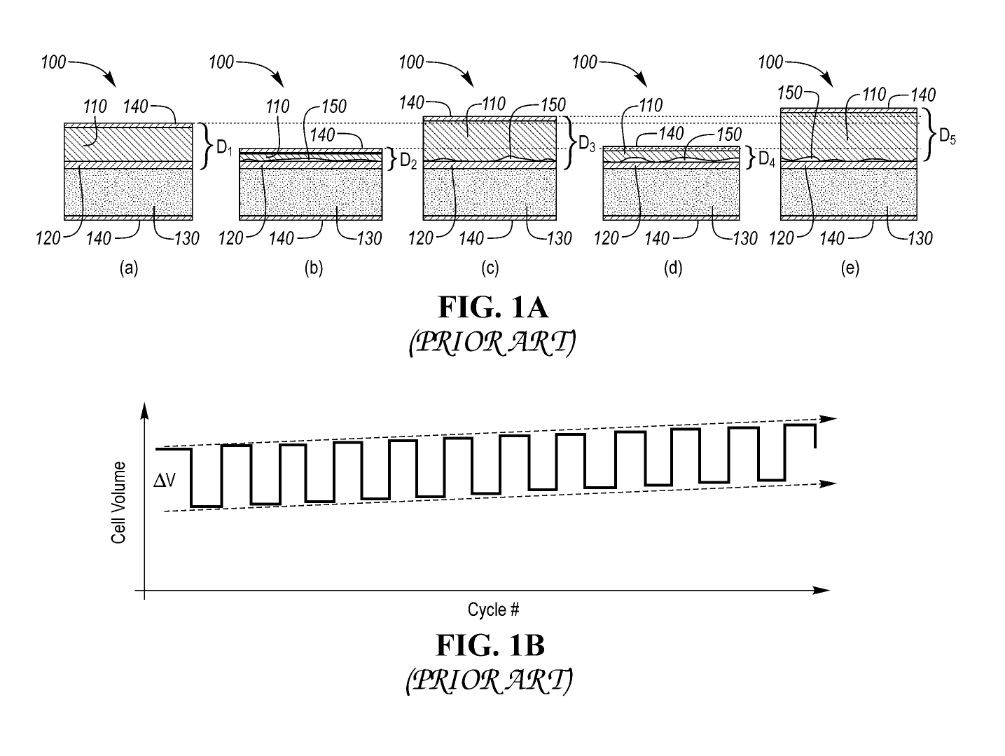

A conventional bulk type solid state battery 100 (SSB or cell), as shown in FIG. 1, contains a lithium metal anode 110 (or negative electrode), a solid electrolyte (SE) separator 120, and a thick cathode 130 (or positive electrode). The anode 110 and cathode 130 each have respective current collectors 140. During cycling of the SSB 100, i.e., repeatedly charging and discharging, lithium metal ions are repeatedly deposited and stripped at the anode surface, respectively. This repeating deposition and stripping causes a significant volume change at the anode of the SSB during each charge/discharge process. In the charged state, as shown in FIG. 1(a), the anode 110 has a charged volume represented by Di. After discharging the SSB 100, as shown in the discharged state illustration FIG. 1(b), the anode 110 has a discharged volume represented by D2 and may develop voids 150 at the Li metal-solid electrolyte interface where lithium ions were stripped during discharge due to the localized occurrence of surface ion depletion. As the SSB 100 is recharged, as shown in FIG. 1(c), the anode 110 volume in the charged state after lithium is deposited, as represented by D3, is greater than the volume represented by Di due to the voids 150 formed at the anode surface. Similarly, as the SSB 100 is discharged, as shown in FIG. 1(d), the anode 110 volume in the discharged state after lithium is stripped, as represented by D4, is greater than the volume represented by D2 due to the formation of additional voids 150 at the Li metal-solid electrolyte interface because of the localized depletion. The SSB 100 continues to see this volume change as cycling continues, as shown by FIG. 1(e), where the anode 110 volume in the charged state, as represented by D₅, is greater than the previous cycle volume represented by D₁ and D₃, as new voids 150 are formed in the anode 110 structure as lithium ions are stripped at the surface. This increasing volume change of a conventional SSB 100 is shown over cycle number in FIG. 1B.

In addition, planar SSB designs, as shown in FIG. 1, may have a reduced effective area of the SE/lithium interface creating greater ohmic loss in the cells due to high current density through the SE/lithium interface at the anode surface, thus reducing performance. Conventional bulk SSBs with anode structure containing porous solid electrolyte structures can increase the effective area of the SE/lithium interface that can decrease the ohmic losses, however, such structure will have limited lithium deposition on the porous solid electrolyte surface because the solid electrolyte material lacks both ionic and electronic conductivity.

The present disclosure relates to a bulk type SSB including an anode structure having a porous solid conductive material with both ionically and electronically conductive properties. By incorporating porous a mixed ionic and electronic conducting (MIEC) material in the anode, metal ions (such as lithium ions) can be deposited and stripped from the within the pores of the MIEC material structure, reducing volume change in the anode at the cell level by reducing localized occurrence of surface ion depletion that would form voids upon discharge. In addition, unlike a conventional planar design, the porous anode design provides increased surface area for the SE/Li metal interface, thus reducing overall cell resistance.

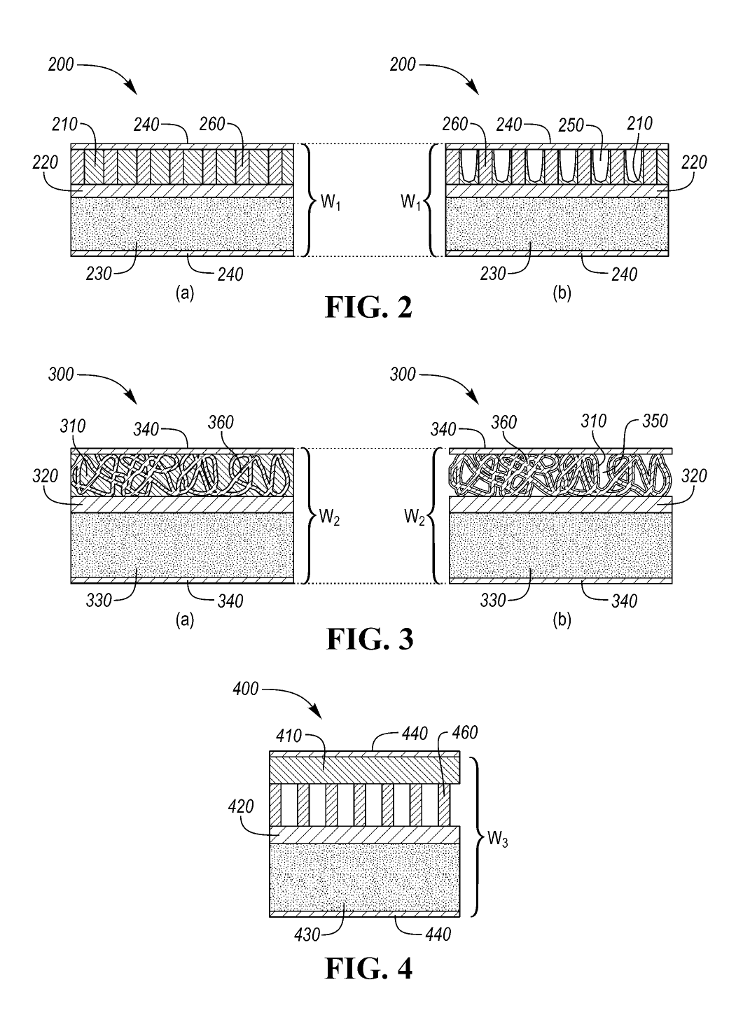

Referring to FIG. 2, a bulk type SSB 200 (or cell) is shown according to an embodiment. The SSB 200 includes an anode 210 (or negative electrode), a solid electrolyte separator 220, and a cathode 230 (or positive electrode). The anode 210 and cathode 230 may be deposited on respective current collectors 240. The solid electrolyte separator 220 may be a non-porous or porous separator. In some embodiments, a non-porous separator may be preferred. The anode 210 further includes a mixed ionic and electronic conducting (MIEC) material 260 and metal ions. For exemplary purposes, lithium metal is disclosed. The MIEC material 260 (or, interchangeably, the solid conductive material 260) forms a porous structure, such that the lithium metal ions fill the pores in the MIEC material 260. The SSB 200 has a cell volume in a charged state as represented by W₁ in FIG. 2(a). In the discharged state, as shown in FIG. 2(b), after lithium ions have been stripped from the pores of the MIEC material 260, the SSB 200 maintains its volume represented by W₁. The porous structure of the MIEC material 260 allows lithium to be stripped and deposited from the anode 210, without structural changes in the anode 210, and provides greater surface area for lithium cycling, thus improving cell performance. The porous structure of the MIEC material 260 also prevents localized depletion of ions at the surface of the separator, which prevents void formation during discharge. The MIEC material 260 may form any type of porous structure, such as, but not limited to continuous or non-continuous pores, as defined by tortuosity of conductive paths formed by the MIEC material 360 forms. The paths may have any suitable geometry, such as, but not limited to, a tortuosity of about 0, where tortuosity defines the curvature of the conductive paths. For example, the continuous pores forming paths having a tortuousity of about 0 (linear with no curvature) may form a pillared (or micro-pillared) structure of solid conductive material, as shown in FIG. 2.

Current collectors 240 may be attached to the anode 210 structure in different ways, and the illustration of the current collector 240 configuration for the micro-pillared structure is for exemplary purposes. In some embodiments (not shown), the current collectors 240 may be absent such that the MIEC material structure in the electrode itself acts as a current collector. In other embodiments, the metallic current collector 240 could be attached to the porous MIEC 260 structure by various methods including the use of an intermediate layer, direct bonding method, or gas-metal eutectic method. For example, the current collector 240 could be bonded to a porous MIEC 260 structure using metal-gas eutectic method. In this method, a metallic current collector 240 is placed on the porous MIEC 260 structure, and the entire structure is heated in the presence of a reactive gas to a temperature below the melting point of the metal but sufficient enough that a eutectic formed between metal and the gas.

Referring to FIG. 3, a bulk type SSB 300 (or cell) is shown according to another embodiment. The SSB 300 includes an anode 310, a solid electrolyte separator 320, and a cathode 330. The anode 310 and cathode 330 are deposited on respective current collectors 340. Current collectors 340 are shown as a non-limiting example of current collector configuration. The solid electrolyte separator 320 may be a porous separator. The anode 310 further includes a mixed ionic and electronic conducting (MIEC) material 360 and lithium metal. The MIEC material 360 forms a porous structure, such that the lithium metal fills the pores in the MIEC material 360. The SSB 300 has a cell volume in a charged state as represented by W₂ in FIG. 3(a). In the discharged state, as shown in FIG. 3(b), after lithium ions have been stripped from the pores of the MIEC material 360, the SSB 300 maintains its cell volume represented by W₂. The porous structure of the MIEC material 360 allows lithium to be stripped and deposited from the anode 310, without structural changes in the anode 310, and provides greater surface area for lithium cycling, thus improving cell performance. The MIEC material 360 may form any type of porous structure, such as, but not limited to continuous or non-continuous pores, as defined by tortuosity of conductive paths formed by the MIEC material 360. The paths may have any suitable geometry, such as, but not limited to, a tortuosity of about 0 or a tortuosity of greater than 0, where tortuosity defines the curvature of the conductive paths. For example, the “closed pores” forming paths having a tortuosity of greater than 0 may have a random solid conductive material (MIEC) structure, as shown in FIG. 3.

The SSB of the present disclosure may be formed by any method, including but not limited to fabricating green sheets. Green sheets are fabricated by casting a slurry containing inorganic solid particles, binder, and plasticizer in a solvent. In an embodiment, three green sheets may be fabricated. The first fabricated sheet is an anode green sheet containing MIEC material and pore formers. The second green sheet is a cathode green sheet containing MIEC material and cathode active material. The third green sheet is a separator green sheet containing solid electrolyte. The separator sheet is sandwiched between anode and cathode sheets, and fired at a desired sintering temperature. During this process pore formers are removed from the anode layer leaving behind pores in the anode MIEC material. After this process, lithium is infiltrated into the porous MIEC anode layer, and current collectors may be applied.

Referring to FIG. 4, the SSB 400 construction to form the SSB of FIG. 2 is shown, according to an embodiment. The SSB 400 includes an anode 410, a solid electrolyte separator 420, and cathode 430. The anode 410 and cathode 430 are deposited on respective current collectors 440. MIEC material 460 forms the pillar (or micro-pillar) structure, as shown in the infiltrated SSB 200 of FIG. 2. Lithium may be infiltrated into the porous structure 460 through any number of methods, including but not limited to, melt filtration and charging. In an exemplary embodiment shown in FIG. 4, lithium is infiltrated by conventional melt infiltration. Melt infiltration is widely used in ceramic processing to infiltrate metals into porous ceramics. In this method, lithium metal is infiltrated into the pores of the MIEC material 460 by melting the lithium under vacuum or under pressure. For example, in the pressure process, when lithium is melted, an external pressure can be applied to infiltrate lithium into the porous structure. Prior to the lithium infiltration, the SSB 400 may have a volume represented by W₃. Upon infiltration, the charged SSB is that of FIG. 2, having the volume represented by W₁. In another exemplary embodiment (not shown), no lithium is incorporated into the porous structure 460 during cell construction, and lithium from the cathode 430 is deposited in the porous structure 460 during initial charging.

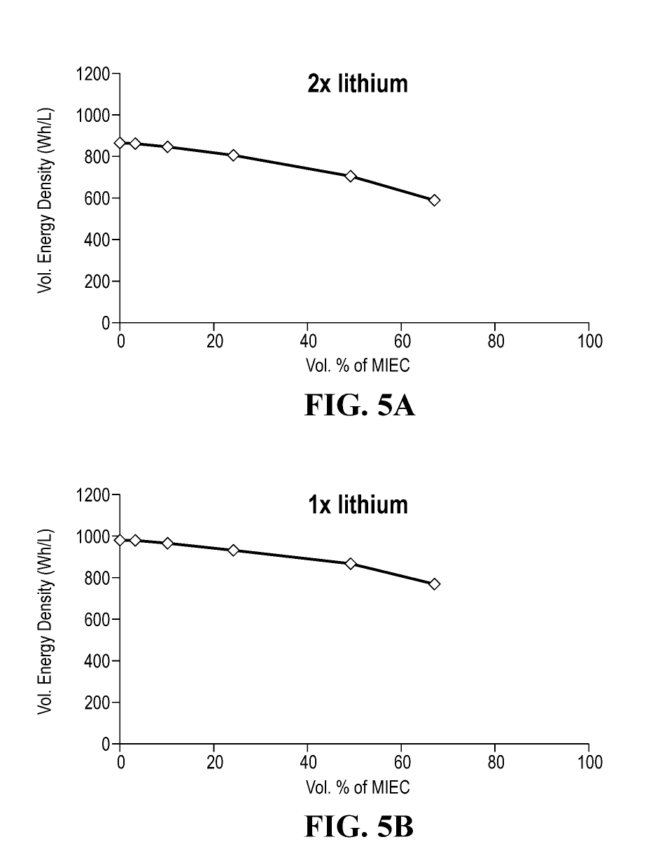

Referring to FIGS. 5A & 5B, graphs of the effect of the volume of MIEC material in the cell on the energy density are shown. For the exemplary pore structure, a 50 μm solid electrolyte separator, 75 μm composite cathode thickness, 4.0 mAh/cm² capacity loading, cathode layer contain 70% active material, 5% carbon, and 25% solid electrolyte was assumed. FIG. 5A depicts an SSB with two times the excess lithium, whereas FIG. 5B shows the one times the excess lithium. The porous MIEC material electrode structure provides a higher energy density that conventional graphite based Li-ion cells. With ˜50% MIEC material at the anode, a SSB containing 100% excess lithium could deliver 712 Wh/L (as shown in FIG. 5A) and a SSB containing no excess lithium could deliver 870 Wh/L (as shown in FIG. 5B). In further refinements, the SSB could be combined with high voltage cathodes such as LNMO to deliver significantly higher energy density.

A bulk type SSB including a porous anode structure having an anode surface with both ionically and electronically conductive properties reduces volume change issues at the cell level. By incorporating a porous mixed ionic and electronic conducting (MIEC) material in anode, lithium metal ions can be deposited and stripped from the within the pores of the MIEC material structure, establishing a source of ions that prevents any localized occurrence of surface ion depletion at the lithium/separator interface during discharge to preclude void formation between the anode and a separator. Thus, changes in cell volume caused by the voids forming during repeated charging/discharging can be reduced by incorporating the porous solid conductive material (MIEC). Also, the surface area for the SE/Li metal interface is increased by using a porous MIEC material, thus reducing overall cell resistance.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electrochemical cell comprising:
a positive electrode; and
a negative electrode including an electronically and ionically conductive solid material defining pores configured to receive metal ions during charge to establish a reservoir that prevents localized occurrence of surface ion depletion during discharge to preclude void formation between the negative electrode and a separator.

2. The electrochemical cell of claim 1, wherein the solid conductive material forms conductive paths defined by at least some of the pores, the paths having a tortuosity of about 0.

3. The electrochemical cell of claim 2, wherein the solid conductive material has a micro-pillar structure defined by the conductive paths between a current collector and the separator.

4. The electrochemical cell of claim 1, wherein the solid conductive material forms conductive paths defined by at least some of the pores, the paths having a tortuosity of greater than 0.

5. The electrochemical cell of claim 4, wherein the paths form a random structure of solid conductive material between a current collector and the separator.

6. The electrochemical cell of claim 1, wherein the solid conductive material is also a current collector.

7. The electrochemical cell of claim 1, further comprising a current collector attached to the solid conductive material.

8. The electrochemical cell of claim 1, wherein the separator is a solid electrolyte separator.

9. The electrochemical cell of claim 8, wherein the separator is non-porous.

10. An electrode for a solid-state battery comprising:
a solid electronically and ionically conductive material defining pores configured to receive metal ions during charge to establish a reservoir that prevents localized occurrence of surface ion depletion during discharge to preclude void formation between the electrode and a separator.

11. The electrode of claim 10, wherein the solid conductive material forms conductive paths defined by at least some of the pores, the paths having a tortuosity of about 0.

12. The electrode of claim 11, wherein the solid conductive material has a micro-pillar structure defined by the paths between a current collector and the separator.

13. The electrode of claim 10, wherein the solid conductive material forms conductive paths defined by at least some of the pores, the paths having a tortuosity of greater than 0.

14. The electrode of claim 13, wherein the paths form a random structure of solid conductive material between a current collector and the separator.

15. The electrode of claim 10, wherein the solid conductive material is also a current collector.

16. An electrochemical cell comprising:
a positive electrode;
a negative electrode including a solid electronically and ionically conductive material defining pores configured to receive lithium ions during charge, and to release the lithium ions during discharge to prevent localized occurrence of surface ion depletion; and
a solid-electrolyte separator between the positive and negative electrodes and defining a lithium ion interface.

17. The electrochemical cell of claim 16, wherein the solid conductive material forms conductive paths defined by at least some of the pores, the paths having a tortuosity of about 0.

18. The electrode of claim 17, wherein the solid conductive material has a micro-pillar structure defined by the paths between a current collector and the separator.

19. The electrode of claim 16, wherein the solid conductive material forms conductive paths defined by at least some of the pores, the paths having a tortuosity of greater than 0.

20. The electrode of claim 19, wherein the paths form a random structure of solid conductive material between a current collector and the separator.
